(19) United States
(12) Patent Application Publication
(10) Pub. No.: US 2008/0154440 A1
(43) Pub. Date: Jun. 26, 2008

(54) Method for defining military refuel orbit

(75) Inventor: Robert S. Carlton, Tijeras, NM (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/305,613

(22) Filed: Dec. 16, 2005

(51) Int. Cl. G01C 23/00

(52) U.S. Cl. 701/3

(57) ABSTRACT

Defining military refuel orbit using unchanged commercial aircraft FMS capability includes uplinking military refuel orbits using an existing commercial FMS datalink function. Refuel orbits are defined as commercial NavDB STAR procedures using RF and TF legs. STAR procedures can also be stored within company routes. Company route names and STAR procedures are stored within a NavDB used in a military unique system. The military system creates a flight plan with custom, place/bearing/distance, place bearing place bearing, or latitude/longitude waypoints to define the military refuel pattern ARIP and ARCP. This is combined with the refuel orbit stored in the military NavDB as a STAR procedure or company route name to define a refuel pattern flight plan. The military system uplinks the flight plan using the existing commercial FMS datalink function. The FMS extracts the appropriate refuel orbit from the commercial FMS NavDB using the uplinked STAR procedure or company route name.

### BACKGROUND OF THE INVENTION

1. Field of the Invention (Technical Field)

The present invention relates to military aircraft Flight Management Systems (FMS) and more particularly to a method for defining military refuel orbit using an unchanged commercial aircraft FMS capability.

2. Background Art

Refuel orbits are defined as Standard Terminal Arrival Route (STAR) procedures using constant radius to a fix (RF) and track to a fix (TF) flight legs in a commercial FMS navigation database (NavDB). The STAR procedures can also be stored within company routes in the commercial NavDB company route file. Storing these refuel orbits in the commercial FMS NavDB is the equivalent of a custom commercial NavDB for a military customer. The names of the company route and/or STAR procedures defining the refuel orbits are also stored in a NavDB of a military unique system (i.e., a Tactical FMS) developed solely for the military aircraft. The Tactical FMS is used to define a commercial FMS flight plan consisting of custom, place/bearing/distance (PBD), place bearing place bearing (PBPB), or latitude/longitude waypoints to define the refuel pattern Air Refueling Initial Point (ARIP) and Air Refueling Control Point (ARCP). The ARIP and ARCP are combined with the appropriate refuel orbit, which is defined as a STAR procedure or company route name in the Tactical FMS NavDB, to form a refuel pattern flight plan. The Tactical FMS then uplinks the military refuel pattern flight plan using the existing commercial FMS datalink function. The problem this invention solves is to produce military aircraft flight management systems rapidly and inexpensively with performance equivalent to existing commercial capabilities.

The problem manifests itself when a military aircraft flight management system must either be changed or created to contain the same capability that already exists within existing commercial aircraft flight management system capability.

Creating a military aircraft flight management system with existing commercial aircraft flight management system capability is presently accomplished by two methods. One method is to modify an existing commercial aircraft flight management system to meet military needs. The second method is to modify an existing military aircraft flight management system to obtain the same capability already contained in an existing commercial aircraft flight management system. Both of these methods force a divergence from the commercial aircraft flight management system, where advances in aircraft flight management technology usually occurs first. For example, the C-141 military flight management system used a military baseline from the C-130 military aircraft flight management system and modified it to contain the aircraft performance management capability from the 777 commercial aircraft flight management system. The C-141 military flight management system simsoft program used a military baseline from the C-141 military aircraft flight management system and modified it to contain the same simulator capabilities as existing commercial aircraft flight management systems.

A third example is the KC-10A GATM military aircraft flight management system proposal which proposed using the MD-10 commercial aircraft flight management system and modifying it to contain military aircraft flight management system capability. There are several specialized military FMSs in use on multiple military aircraft, such as C-141C, C-130J, C-17, P-3, VC-25. Many of these specialized military FMSs are derived from commercial products that required changes to the commercial product.

Military aircraft flight management system capability is contained within a single system that is divergent from commercial aircraft flight management system capability; this divergence forces the need to add any new capability from existing commercial capability using one of the methods described above. Since the military aircraft flight management system must be changed, significant cost is incurred to gain capability that already exists in the commercial aircraft flight management system. These attempted prior art solutions have failed to recognize the complexity involved in changing existing flight management systems.

None of the prior art methods use an unchanged commercial FMS capability to be used with no changes to fly military refueling orbits. The invention makes maximum use of already existing technology rather than repeating development for the existing technology.

### SUMMARY OF THE INVENTION

### Disclosure of the Invention

The present invention is a method for defining a refuel orbit using an unchanged commercial FMS capability. It defines a method for uplinking military refuel orbits using existing commercial off the shelf FMS datalink functions. This Tactical FMS system executes all military unique functions and formats the input/output data to interface the commercial FMS with a military aircraft.

The present invention stores military refuel orbits as STAR procedures or company routes in a commercial FMS NavDB. Storing military refuel orbits in the commercial FMS NavDB is a military customer's custom NavDB for the commercial FMS. The invention links a separate function or device, the Tactical FMS, to the commercial FMS by placing the names of the commercial NavDB refuel orbits into a NavDB used by the Tactical FMS. The Tactical FMS is used to perform all military unique functions so that the Tactical FMS can be tailored to many different aircraft. The Tactical FMS is used to calculate the appropriate refuel pattern size using data entered by the flight crew in a user interface format that matches the commercial FMS user interface. And finally, the Tactical FMS is used to construct a complete refuel pattern that is uplinked to an unchanged commercial FMS using the commercial FMS's existing datalink function.

A primary object of the present invention is to provide military flight management systems containing already existing commercial flight management system capability.

The primary advantage of the present invention is that it produces military aircraft flight management systems rapidly and inexpensively with performance equivalent to existing commercial capabilities.

Another advantage of the invention is that it is easier to make since all changes are made in the much less complex Tactical FMS.

A further advantage of the invention is that it is safer since the existing, certified commercial flight management system does not require any changes.

Yet another advantage of the present invention is that it avoids the duplication of system capabilities common between the commercial and military flight management systems.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a flow chart showing the preferred method for defining a military refuel orbit.

### DESCRIPTION OF THE PREFERRED EMBODIMENTS

### Best Modes for Carrying Out the Invention

A Tactical FMS or other device used to uplink the military refuel orbit flight plan is developed as a separate avionics box or partition if installed in an Integrated Modular Avionics (IMA) architecture. Refuel orbits defined to cover all combinations of refuel orbit sizes needed for a particular military aircraft are stored in a commercial FMS NavDB. The aircraft flight crew specifies the information to define the desired refuel orbit (e.g., refuel orbit name), the true airspeed (TAS), and the ARIP to ARCP drift the orbit will be flown with in the Tactical FMS using (M)CDU pages with a similar human factors interface to those in the existing commercial FMS. The Tactical FMS uses the flight crew entered information to determine the refuel orbit size, ARIP, and ARCP, then uplinks the defined refuel orbit and associated ARIP and ARCP using the commercial FMS's existing datalink interface.

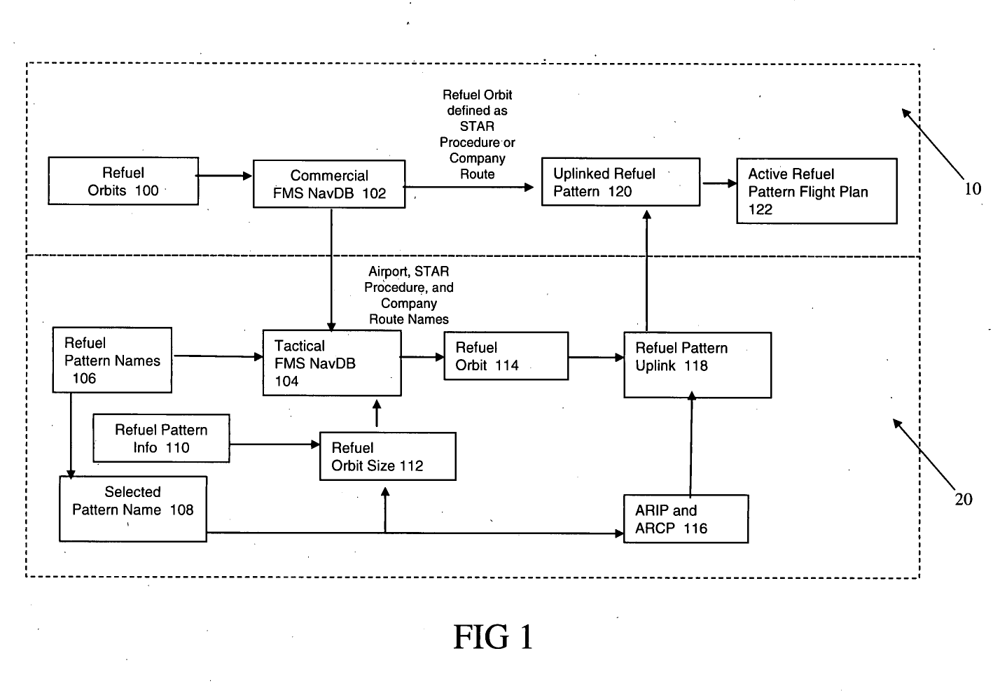

The preferred method of the invention is shown in FIG. 1. The upper portion of the drawing depicts a commercial FMS 10 and the lower portion depicts a military unique system (hereinafter referred to as a Tactical FMS) 20.

In step 100, using flight management system RF and TF flight legs, define refuel orbits consisting of standard terminal arrival route (STAR) procedures to cover all combinations of refuel orbit sizes needed for a particular military aircraft and uniquely name the refuel orbits.

In step 102, place the refuel orbits defined in step 100 into the STAR procedures portion of a commercial flight management system (FMS) 10 navigation database. Assign the STAR procedures to a uniquely named airport defined in the airports portion of a commercial FMS 10 navigation database. As an option, place the STAR procedures into uniquely named company routes and place the company routes into the company route portion of a commercial FMS 10 navigation database.

In step 104, place the airport, STAR procedure, and company route names assigned in step 102 into a navigation database used by the Tactical FMS 20 that is used to define refuel patterns uplinked into the commercial FMS 10.

In step 106, place the names of all needed refuel patterns defined in the appropriate military documentation into the navigation database used by the Tactical FMS 20.

In step 108, the flight crew uses the Tactical FMS 20 to select the refuel pattern needed for a specific military mission by selecting from the names defined in step 106.

In step 110, the flight crew uses the Tactical FMS 20 to define critical refuel pattern information such as true airspeed, bank angle, etc.

In step 112, the Tactical FMS 20 uses the information entered in steps 108 and 110 to calculate the required refuel orbit size.

In step 114, using the refuel orbit size determined in step 112, the Tactical FMS 20 extracts the appropriate refuel orbit from the STAR procedure or company route names defined in step 104.

In step 116, the Tactical FMS 20 creates custom, place/bearing/distance (PBD), place bearing place bearing (PBPB), or latitude/longitude (lat/lon) waypoints to define the refuel pattern ARIP and ARCP for the refuel pattern selected in step 108. If custom waypoints are used, they must be contained in the navigation databases defined in steps 102 and 104. The Tactical FMS 20 must extract the appropriate custom waypoint from the navigation database based on the refuel pattern selected in step 108.

In step 118, upon command from the aircraft flight crew, the Tactical FMS 20 sends the ARIP, ARCP, and refuel orbit determined in steps 114 and 116 to the commercial FMS 10 as an uplink using the commercial FMS's existing datalink function.

In step 120, when the uplink initiated in step 118 is complete, the flight crew accepts the uplink in the commercial FMS 10.

In step 122 the flight crew completes any additional flight planning and then uses the defined flight plan to fly the refuel pattern selected in step 118.

The description above is the preferred embodiment of the present invention. Each of the steps of the method described must be completed; however, they need not be completed only in the sequence set forth above. This disclosure is intended to include all sequences of these steps. Further, uplinking the ARIP and ARCP in step 118 may not be necessary in all cases.

As an example of the use of the present invention, suppose a military user wanted to use a commercial aircraft that already contains a FMS as a refueling tanker. The military user specifies which refueling patterns 106 must be supported by the tanker and the commercial FMS NavDB supplier develops refuel orbits 100, as STAR procedures and/or company routes associated with a uniquely named airport, that accommodate all specified patterns 106 and all needed sizes for the specified orbits 100. The resulting military user commercial NavDB 102 is loaded into the commercial FMS 10. In addition, a Tactical FMS NavDB 104 is created that contains the STAR procedure and company route names for the refuel orbits 100 defined in the commercial FMS NavDB 102. Using a Tactical FMS 20 developed to support the military user's tanker requirements, the tanker flight crew enters information 110 into the Tactical FMS 20 that will allow the Tactical FMS 20 to determine which refuel pattern 108 is needed and calculate the required refuel orbit size 112. The Tactical FMS 20 then extracts the appropriate refuel orbit 114 from the available refuel orbits stored in the Tactical FMS NavDB 104. The Tactical FMS 20 also determines if a refuel pattern ARIP and ARCP is required and calculates the appropriate locations of the ARIP and ARCP 116. The Tactical FMS 20 then combines the chosen refuel orbit 114 with the associated ARIP and ARCP 116, if needed, and uplinks the resulting refuel pattern flight plan using the commercial FMS's existing datalink function 118. In the commercial FMS 10, the refuel pattern uplink from the Tactical FMS 20 is received as a modified commercial FMS flight plan 120. The tanker flight crew can then accept the uplinked refuel pattern flight plan so that the uplinked refuel orbit that was extracted from the commercial FMS NavDB 102 as a STAR procedure or company route becomes the active flight plan flown by the commercial FMS 122. The tanker flight crew also uses the commercial FMS to execute other FMS flight planning, such as flying direct-to specific fixes, to/from destination airports, or the like, to execute military missions.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

1. A method of providing a military refuel orbit to a commercial flight management system, the method comprising the steps of:
(a) defining, within a commercial flight management system, a plurality of refuel orbits to cover combinations of refuel orbit sizes;
(b) naming each of the plurality of refuel orbits;
(c) storing the named plurality of refuel orbits into a commercial flight management system navigation database;
(f) providing the named plurality of refuel orbits to a tactical flight management system navigation database;
(g) defining refuel pattern information within the tactical flight management system;
(h) calculating, within the tactical flight management system, a refuel orbit size based on the defined refuel pattern information;
(i) selecting a named refuel orbit from the provided named plurality of refuel orbits that closely matches the calculated refuel orbit size; and
(j) uplinking the selected named refuel orbit from the tactical flight management system to the commercial flight management system, wherein both the tactical flight management system and the commercial flight management system are within a single aircraft.

2. The method of claim 1 wherein the refuel pattern information comprises true airspeed and an air refueling initial point (ARIP) to air refueling control point (ARCP) drift.

3. The method of claim 1 wherein the step of calculating a refuel orbit size further comprises determining waypoints.

4. The method of claim 3 wherein the waypoints comprise an air refueling initial point (ARIP) and an air refueling control point (ARCP).

5. (canceled)

6. The method of claim 1 wherein the plurality of refuel orbits comprise uniquely named standard terminal arrival route (STAR) procedures.

7. The method of claim 6 wherein the STAR procedures comprise radius to a fix (RF) and track to a fix (TF) flight legs.

8. (canceled)

9. The method of claim 1 wherein the step of naming comprises providing a unique name to each company route.

10. The method of claim 1 further comprising the step of placing standard terminal arrival route (STAR) procedures into a company route in the commercial navigation database.

11. The method of claim 1 further comprising the step of assigning standard terminal arrival route (STAR) procedures to an airport in the commercial navigation database.

12. The method of claim 1 further comprising placing airport names, standard terminal arrival route (STAR) procedures, and company route names into the tactical flight management system navigation database.

13. (canceled)

14. (canceled)

15. The method of claim 1 further comprising the step of extracting a refuel orbit from a standard terminal arrival route (STAR) procedure or company route names stored in the tactical flight management system navigation database.

16. (canceled)

17. An apparatus for providing a refuel orbit to a commercial flight management system comprising:
a means for defining and naming, within the commercial flight management system, a plurality of refuel orbits;
a memory for storing a the named plurality of refuel orbits into a commercial navigation database;
a means for providing names of the named plurality of refuel orbits stored in the commercial navigation database to a tactical flight management system navigation database;
a means for providing names of the airports which the named plurality of refuel orbits are assigned to;
a means for providing refuel pattern information to a tactical flight management system;
a means for selecting a named refuel orbit from the named plurality of refuel orbits that closely matches the refuel pattern information; and
a transmitter and receiver for uplinking the selected named refuel orbit from the tactical flight management system to the commercial flight management system, wherein both the tactical flight management system and the commercial flight management system are on the aircraft.

18. The apparatus of claim 17 further comprising a means for formatting input and output data to interface the commercial flight management system with other military systems.
